(19) United States
(12) Patent Application Publication
(10) Pub. No.: US 2024/0297946 A1
(43) Pub. Date: Sep. 5, 2024

(54) SERVER EXECUTING SPECIFIC PROCESS RELATED TO CONFIGURATION INFORMATION OF DEVICE USING COMMUNICATION SESSION ESTABLISHED BETWEEN THE SERVER AND THE DEVICE

(71) Applicant: BROTHER KOGYO KABUSHIKI KAISHA, Nagoya (JP)

(72) Inventor: Ken SAITO, Tokoname (JP)

(73) Assignee: BROTHER KOGYO KABUSHIKI KAISHA, Nagoya (JP)

(21) Appl. No.: 18/431,026

(22) Filed: Feb. 2, 2024

(30) Foreign Application Priority Data
Mar. 4, 2023 (JP) 2023-033260

(51) Int. Cl. H04N 1/327; H04N 1/00

(52) U.S. Cl. CPC H04N 1/32793; H04N 1/00962

(57) ABSTRACT

In a server, a controller is configured to perform: (a) establishing, in response to a specific process request transmitted from a device, a communication session with the device; and (b) executing a specific process related to configuration information on the device using the communication session established in (a). The executing in (b) includes: (b-1) receiving an acquisition instruction from a terminal device; (b-2) transmitting, in response to receiving the acquisition instruction, a transmission request to the device using the communication session; (b-3) receiving the configuration information from the device using the communication session; (b-4) transmitting, in response to receiving the configuration information, information based on the configuration information to the terminal device; (b-5) receiving a modification instruction from the terminal device; and (b-6) transmitting, in response to receiving the modification instruction, a modification request to the device using the communication session. The modification request requesting to modify the configuration information.

### REFERENCE TO RELATED APPLICATIONS

This application claims priority from Japanese Patent Application No. 2023-033260 filed on Mar. 4, 2023. The entire content of the priority application is incorporated herein by reference.

### BACKGROUND ART

In a conventional remote monitoring system, a working machine transmits the working machine's own status information and the date and time to a server through wireless communication. The server generates a simulated image displaying the working machine's status information in an image simulating the display device of the working machine. A monitoring terminal for the service staff, which is connected to the server and capable of communicating with the same, displays this simulated image. This configuration is intended to facilitate communication between the service staff and the user of the working machine so that problems occurring on the working machine can be quickly resolved.

### SUMMARY

However, the burden on the user of the working machine may be greater since the conventional technology described above can only display status information for the working machine on the monitoring terminal for the service staff.

In view of the foregoing, it is an object of the present disclosure to provide a technology for reducing the burden on users of devices through remote operations.

In order to attain the above and other object, according to one aspect, the present disclosure provides a server including a communication interface; and a controller. The communication interface is connectable to: a device; and a terminal device. The device includes a device memory. Configuration information on the device is stored in the device memory. The server is communicable with the device and the terminal device via the communication interface. The controller is configured to perform: (a) establishing; and (b) executing. The establishing in (a) establishes, in response to a specific process request transmitted from the device, a communication session with the device through the communication interface. The executing in (b) executes a specific process related to the configuration information on the device using the communication session establishes in (a). The executing in (b) includes: (b-1) receiving; (b-2) transmitting; (b-3) receiving; (b-4) transmitting; (b-5) receiving; and (b-6) transmitting. The receiving in (b-1) receives an acquisition instruction from the terminal device. The acquisition instruction instructs to acquire the configuration information. The transmitting in (b-2) transmits, in response to receiving the acquisition instruction in (b-2), a transmission request to the device using the communication session. The transmission request requests to transmit the configuration information. The receiving in (b-3) receives the configuration information from the device using the communication session. The transmitting in (b-4) transmits, in response to receiving the configuration information in (b-3), information based on the configuration information to the terminal device. The receiving in (b-5) receives a modification instruction from the terminal device. The modification instruction instructs to modify the configuration information. The transmitting in (b-6) transmits, in response to receiving the modification instruction in (b-5), a modification request to the device using the communication session. The modification request requests to modify the configuration information.

With the above configuration, when receiving the acquisition instruction from the terminal device, the server receives the configuration information from the device and transmits the information based on the configuration information to the terminal device. Hence, the operator of the terminal device can reference the configuration information on the device at a separate location from the location at which the device is installed, for example. Furthermore, when receiving the modification instruction from the terminal device, the server transmits to the device the modification request requesting to modify the configuration information. Therefore, the operator of the terminal device can modify the configuration information on the device, even when in a location different from the installation location of the device, for example. Thus, by referencing and modifying the configuration information on the device through remote operations, the operator of the terminal device can perform maintenance on the device, such as adjusting the configuration information on the device, thereby reducing the burden on the user of the device.

According to another aspect, the present disclosure also provides a system including: a device; a terminal device; and a server. The device includes: a device memory; and a device controller. Configuration information on the device is stored in the device memory. The terminal device includes: a terminal controller. The server includes: a communication interface; and a server controller. The communication interface is connectable to the device and the terminal device. The server is communicable with the device and the terminal device via the communication interface. The device controller is configured to perform: (a) transmitting. The transmitting in (a) transmits a specific process request to the server. The server controller is configured to perform: (b) establishing; and (c) executing. The establishing in (b) establishes, in response to the specific process request transmitted from the device in (a), a communication session with the device through the communication interface. The executing in (c) executes a specific process related to the configuration information on the device using the communication session established in (b). The terminal controller is configured to perform: (d) transmitting; and (e) transmitting. The transmitting in (d) transmits an acquisition instruction to the server. The acquisition instruction instructs to acquire the configuration information. The transmitting in (e) transmits a modification instruction to the server. The modification instruction instructs to modify the configuration information. The executing in (c) includes: (c-1) receiving; (c-2) transmitting; (c-3) receiving; (c-4) transmitting; (c-5) receiving; and (c-6) transmitting. The receiving in (c-1) receives the acquisition instruction transmitted from the terminal device in (d). The transmitting in (c-2) transmits, in response to receiving the acquisition instruction in (c-1), a transmission request to the device using the communication session. The transmission request requests to transmit the configuration information. The receiving in (c-3) receives the configuration information from the device using the communication session. The transmitting in (c-4) transmits, in response to receiving the configuration information in (c-3), information based on the configuration information to the terminal device. The receiving in (c-5) receives the modification instruction transmitted from the terminal device in (e). The transmitting in (c-6) transmits, in response to receiving the modification instruction in (c-5), a modification request to the device using the communication session. The modification request requests to modify the configuration information.

According to still another aspect, the present disclosure also provides a non-transitory computer-readable storage medium storing a set of computer-readable instructions for a server. The server includes: a communication interface; and a computer. The communication interface is connectable to a device; and a terminal device. The device includes a device memory. Configuration information on the device is stored in the device memory. The server is communicable with the device and the terminal device via the communication interface. The set of computer-readable instructions, when executed by the computer, causes the server to perform: (a) establishing; and (b) executing. The establishing in (a) establishes, in response to a specific process request transmitted from the device, a communication session with the device through the communication interface. The executing in (b) executes a specific process related to the configuration information on the device using the communication session established in (a). The executing in (b) includes: (b-1) receiving; (b-2) transmitting; (b-3) receiving; (b-4) transmitting; (b-5) receiving; and (b-6) transmitting. The receiving in (b-1) receives an acquisition instruction from the terminal device. The acquisition instruction instructs to acquire the configuration information. The transmitting in (b-2) transmits, in response to receiving the acquisition instruction in (b-1), a transmission request to the device using the communication session. The transmission request requests to transmit the configuration information. The receiving in (b-3) receives the configuration information from the device using the communication session. The transmitting in (b-4) transmits, in response to receiving the configuration information in (b-3), information based on the configuration information to the terminal device. The receiving in (b-5) receives a modification instruction from the terminal device. The modification instruction instructs to modify the configuration information. The transmitting in (b-6) transmits, in response to receiving the modification instruction in (b-5), a modification request to the device using the communication session. The modification request requests to modify the configuration information.

### BRIEF DESCRIPTION OF DRAWINGS

FIG. 1 is a block diagram illustrating the configuration of a system including a multifunction peripheral (MFP), a terminal device, and a server.

FIG. 2A is an explanatory diagram for a job management table.

FIG. 2B is an explanatory diagram for a configuration information database.

FIG. 3 is a sequence diagram illustrating the first part of a maintenance process.

FIG. 4 is a sequence diagram illustrating the second part of the maintenance process.

FIG. 5 is a sequence diagram illustrating the third part of the maintenance process.

FIG. 6 is a sequence diagram illustrating the fourth part of the maintenance process.

FIG. 7 is a diagram illustrating an example of a maintenance screen displayed on the terminal device.

FIGS. 8A through 8D illustrate examples of display screens on the MFP, in which: FIG. 8A is a diagram illustrating an example of an initial screen; FIG. 8B is a diagram illustrating an example of a menu screen; FIG. 8C is a diagram illustrating an example of a code entry screen; and FIG. 8D is a diagram illustrating an example of a standby screen.

### DESCRIPTION

### A. Embodiment

### A-1. Configuration of System 1000

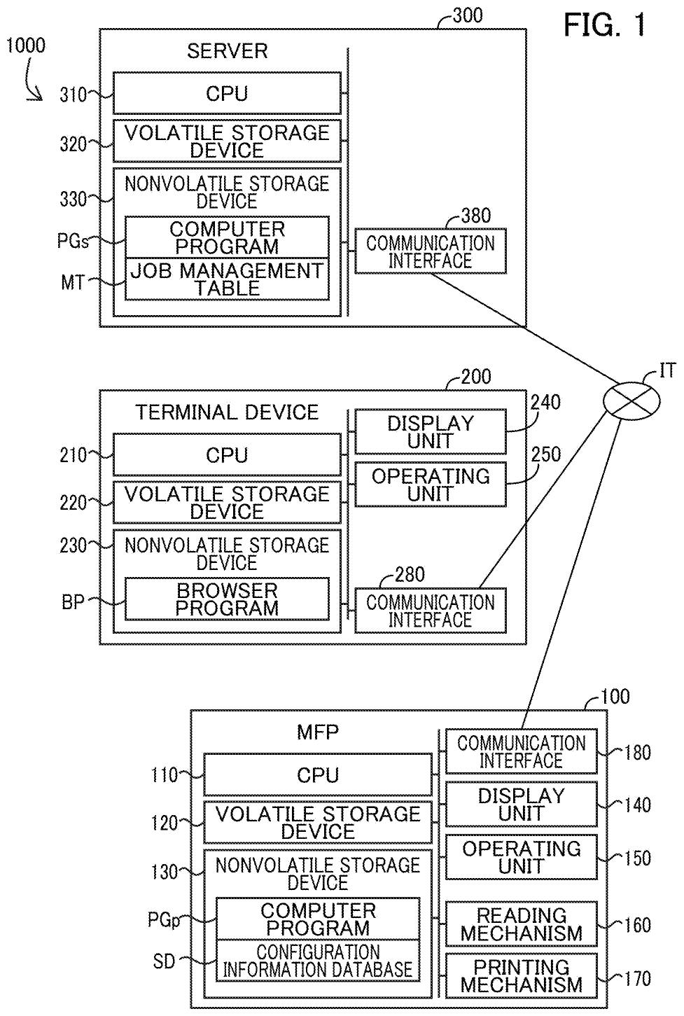

FIG. 1 is a block diagram illustrating the configuration of a system 1000. The system 1000 includes a multifunction peripheral (MFP) 100, a terminal device 200, and a server 300.

The MFP 100 is a device that prints using ink as the colorant and consumes ink while printing. The MFP 100 includes: a CPU 110 serving as a controller of the MFP 100; a volatile storage device 120 such as DRAM; and a nonvolatile storage device 130 such as a hard disk drive or flash memory. The MFP 100 also includes: a display unit 140, such as a liquid crystal display, for displaying images; an operating unit 150 including buttons, a touchscreen, and the like for receiving user operations; a reading mechanism 160; a printing mechanism 170; and a communication interface 180.

The communication interface 180 is an interface for connecting to an internet IT, such as a wired interface compliant with Ethernet (registered trademark) or a wireless interface compliant with the Wi-Fi (registered trademark) standard. “Ethernet” is a Japanese registered trademark of FUJIFILM Business Innovation Corp. “Wi-Fi” is a Japanese registered trademark of Wi-Fi Alliance.

The CPU 110 is an arithmetic device (processor) that performs data processing. The volatile storage device 120 provides a buffer area for temporarily storing various intermediate data generated when the CPU 110 executes processes. The nonvolatile storage device 130 stores a computer program PGp for controlling the MFP 100, and a configuration information database SD that records various configuration information described later.

In the present embodiment, the computer program PGp is stored in the nonvolatile storage device 130 in advance at the time the MFP 100 is manufactured. As an alternative, the computer program PGp may be downloaded from a server connected to the MFP 100 via the internet IT or may be recorded on a CD-ROM or another storage medium and supplied in this form.

By executing the computer program PGp, the CPU 110 implements various processes for controlling the MFP 100. For example, the CPU 110 executes a printing process by controlling the printing mechanism 170 to print images and executes a reading process by controlling the reading mechanism 160 to generate scan data. The CPU 110 also functions as a web browser by executing the computer program PGp. When functioning as a web browser, the CPU 110 can use services provided by the server 300. As a web browser, for example, the CPU 110 executes a maintenance process described later in conjunction with the server 300 and terminal device 200.

The reading mechanism 160 generates scan data by optically reading an original document using a one-dimensional image sensor under control of the CPU 110. The printing mechanism 170 executes a print under control of the CPU 110. The printing mechanism 170 in the present embodiment is an inkjet printing mechanism that prints images on recording media using a plurality of types of ink (e.g., ink in the four colors cyan (C), magenta (M), yellow (Y), and black (K)). As an alternative, the printing mechanism 170 may be an electrophotographic printing mechanism that prints images on recording media using toner accommodated in toner cartridges as the colorant.

The terminal device 200 is a personal computer or another computing device. The terminal device 200 is installed at a location different from the location in which the MFP 100 is installed (e.g., the user's home or workplace), such as a service center managed by the manufacturer of the MFP 100. The terminal device 200 is operated by a service center employee (hereinafter called the “operator”).

The terminal device 200 includes: a CPU 210 serving as a controller of the terminal device 200; a volatile storage device 220 such as DRAM; and a nonvolatile storage device 230 such as a hard disk drive or flash memory. The terminal device 200 also includes: a display unit 240, such as a liquid crystal display, for displaying images; an operating unit 250 including a mouse, keyboard, and the like for receiving user operations; and a wired or wireless communication interface 280 for connecting to the internet IT.

The CPU 210 is an arithmetic device (processor) that performs data processing. The volatile storage device 220 provides a buffer area for temporarily storing various intermediate data generated when the CPU 210 executes processes. The nonvolatile storage device 230 stores a browser program BP.

The CPU 210 functions as a web browser by executing the browser program BP. When functioning as a web browser, the CPU 210 executes the maintenance process described later in conjunction with the MFP 100 and server 300. The browser program BP is provided by a company that provides the operating system (OS) for the terminal device 200, for example, and is installed on the terminal device 200.

The server 300 is a computing device, such as a cloud server, operated by a company that manufactures or sells the MFP 100, for example. The server 300 includes: a CPU 310 serving as a controller of the server 300; a volatile storage device 320 such as DRAM; a nonvolatile storage device 330 such as a hard disk drive or flash memory; and a wired or wireless communication interface 380 for connecting to the internet IT. The server 300 is connected to and capable of communicating with both the MFP 100 and terminal device 200 via the internet IT.

The CPU 310 is an arithmetic device (processor) that performs data processing. The volatile storage device 320 provides a buffer area for temporarily storing various intermediate data generated when the CPU 310 executes processes. The nonvolatile storage device 330 stores a computer program PGs, and a job management table MT described later.

The company operating the server 300 may provide the computer program PGs in an uploaded form, for example. The CPU 310 of the server 300 executes the computer program PGs to provide web services to the MFP 100. The web services are services provided to the MFP 100 serving as a client, and includes a service that, for example, the server 300 provides a user interface (UI) screen to the display unit 140 of the MFP 100 and executes applications based on user instructions inputted via the UI screen. Web services include various services for expanding the printing function and scanning function of the MFP 100. Examples of web services may include a service that provides templates for greeting cards and prints the greeting cards using the templates, and a service that uploads scan data to a publicly known cloud storage service. Web services that the server 300 provides in the present embodiment further include a maintenance service for executing the maintenance process described later.

Although FIG. 1 depicts only one MFP 100 and one terminal device 200, the server 300 provides the web services, such as the maintenance service, to a plurality of MFPs, printers, and other devices. Below, a maintenance process that implements the maintenance service on a single MFP 100 will be described, but this process is executed independently for each printer being provided services.

### A-2. Job Management Table MT and Configuration Information Database SD

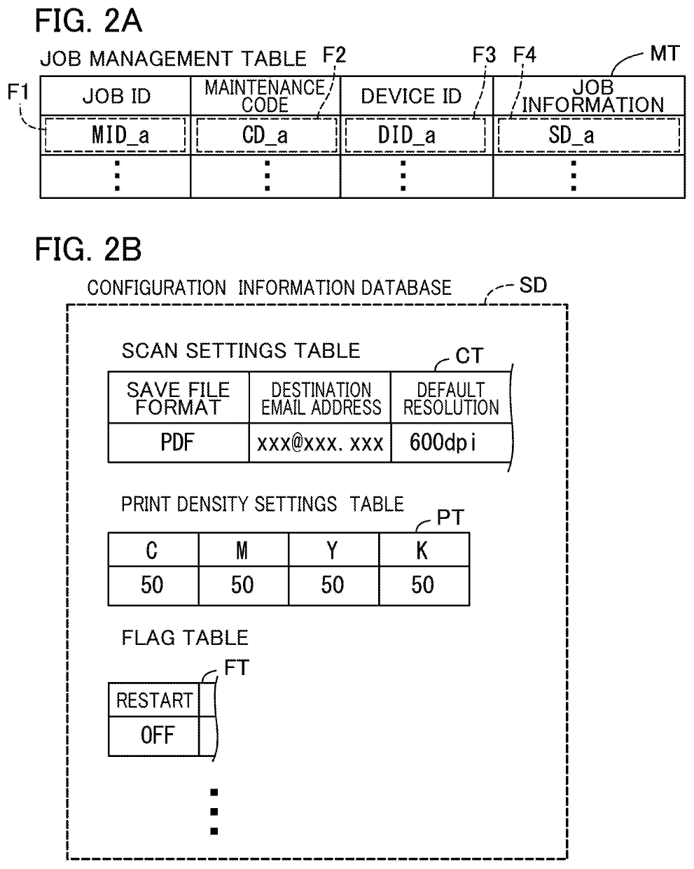

Next, a description will be provided for the job management table MT stored in the nonvolatile storage device 330 of the server 300 and the configuration information database SD stored in the nonvolatile storage device 130 of the MFP 100. FIG. 2 is an explanatory diagram for the job management table MT and configuration information database SD.

The job management table MT in FIG. 2A is used for managing a series of tasks in a maintenance process performed for a single MFP 100 as one job (hereinafter called a “maintenance job”). The job management table MT registers a maintenance code, a device ID, and job information in association with each job ID.

The job ID is identification information identifying a series of tasks performed for a single MFP 100 (a maintenance job). The maintenance code is identification information used temporarily to associate a job ID with a device ID. A device ID is identification information identifying a device (e.g., the MFP 100) and is a value unique to the device, such as a MAC address or a serial number. The device ID is preset in the MFP 100 when the MFP 100 is manufactured, for example. The job information is information acquired from the MFP 100 during a maintenance job (e.g., configuration information) or instructions acquired from a terminal device 200 (e.g., an acquisition instruction or modification instruction).

The configuration information database SD registers various configuration information related to the MFP 100. The configuration information database SD in FIG. 2B is configured of a plurality of tables including a scan settings table CT, a print density settings table PT, and a flag table FT.

The scan settings table CT records scanner-related settings including information specifying a save file format, a destination email address, and a default resolution, for example. The save file format is the file format in which the generated scan data is to be saved. The destination email address specifies an email address to which the generated scan data is to be transmitted by email. The default resolution is the resolution at which scan data is to be generated by default.

The print density settings table PT records density setting values set for each of the CMYK colors of ink. For example, density setting values are set within a predetermined numerical range (e.g., 1-100), where a larger value indicates a higher density. The higher the density setting value, the greater the quantity of ink ejected for forming one dot. As a result, the larger the density setting value, the higher the color density recorded with ink.

The flag table FT records various flags for controlling the MFP 100. The flag table FT includes a restart flag. When the restart flag is set to ON, for example, the MFP 100 is restarted after a prescribed time (after a few seconds, for example).

The configuration information described above is just one example. The configuration information database SD may include information on print settings, scan settings, copy settings, facsimile settings, wired or wireless network settings, and any other settings related to the MFP 100.

### A-3. Maintenance Process

The maintenance process is performed to fulfill a maintenance service, which is one of the web services provided by the server 300. In the maintenance process, the server 300 acquires and modifies the configuration information recorded in the configuration information database SD on the MFP 100 on the basis of instructions from the terminal device 200. For example, when any of various errors or malfunctions occur on the MFP 100, such as a communication error or a low print density, the maintenance process is performed to resolve such errors or malfunctions.

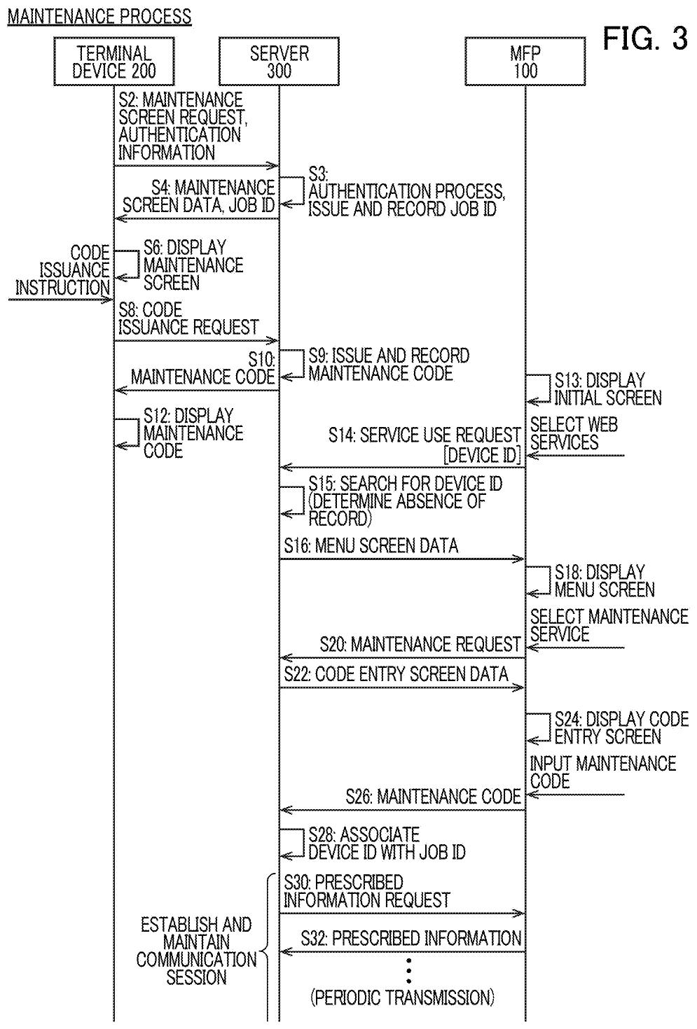

FIGS. 3 through 6 are sequence diagrams for the maintenance process. When an error or a malfunction occurs on the MFP 100, a user of the MFP 100 calls the support center for assistance, for example. When a call is received from a user, an operator at the support center operates the terminal device 200 to start up a web browser and inputs instructions into the web browser to access a prescribed URL. The prescribed URL is the URL of a portal site created for assisting terminal devices which is for maintenance service provided by the server 300. The portal site for terminal devices cannot be accessed by general users because authentication is required for access but can be accessed by operators at the support center. This action initiates the maintenance process illustrated in FIGS. 3 through 6.

In S2 of FIG. 3, the terminal device 200 (the web browser) transmits a maintenance screen request and authentication information (e.g., an account name and a password) to the server 300. Communication between the terminal device 200 and server 300 is implemented using Hypertext Transfer Protocol (HTTP). The terminal device 200 transmits data to the server 300 as an HTTP request, and the server 300 transmits data to the terminal device 200 as an HTTP response to the HTTP request received immediately before. For example, a maintenance screen request is an HTTP request transmitted to the prescribed URL described above.

Upon receiving the maintenance screen request and authentication information, in S3 the server 300 executes an authentication process using the authentication information. When authentication is successful, the server 300 issues and records a job ID. For example, the job ID “MID_a” is recorded in the job management table MT as indicated in the box F1 depicted by dashed lines in FIG. 2A. Specifically, the server 300 issues a string consisting of alphanumeric characters, symbols and the like, for example, as the job ID, and creates a new record corresponding to this job ID in the job management table MT. The server 300 records the issued job ID in the field of the job ID in the newly-created record (the box F1 in FIG. 2A). Note that in the following description and drawings, “MID_a”, which is listed as a job ID, is not itself a character string representing a job ID, but is used for convenience of explanation as a kind of reference symbol representing the character string itself.

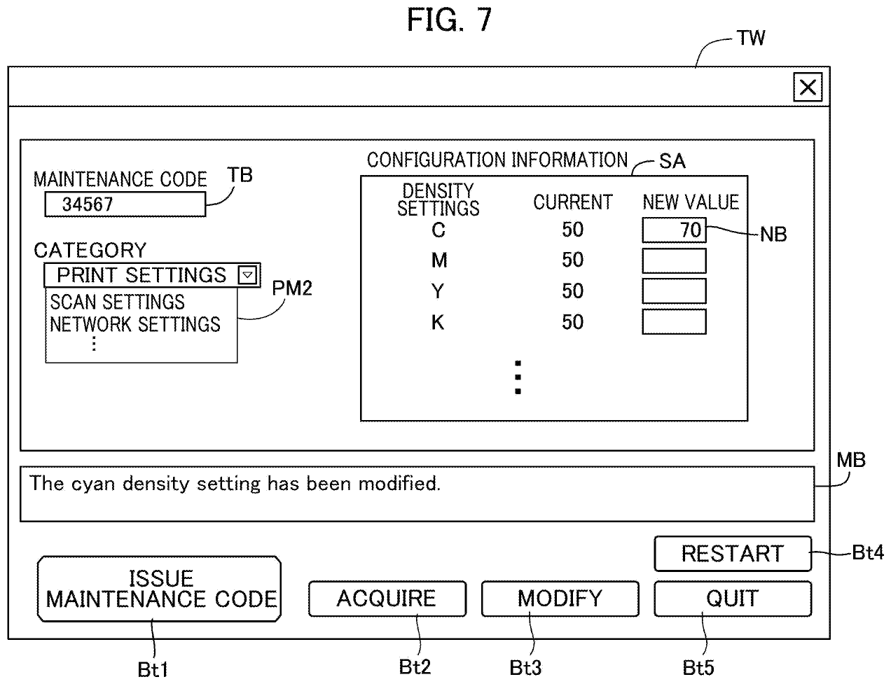

In S4 the server 300 transmits maintenance screen data and the job ID to the terminal device 200. Hereafter, this job ID is included in each HTTP request sent from the terminal device 200 to the server 300. In this way, the server 300 can recognize that the source of the HTTP request is the terminal device 200 that has sent the maintenance screen request in S2. Upon receiving the maintenance screen data, in S6 the terminal device 200 displays a maintenance screen on the display unit 240 based on this maintenance screen data. FIG. 7 is a diagram illustrating an example of a maintenance screen TW.

The operator inputs an instruction to issue a maintenance code (a code issuance instruction) into the terminal device 200 via the maintenance screen TW. For example, an ISSUE MAINTENANCE CODE button Bt1 is provided in the maintenance screen TW in FIG. 7, and the operator inputs a code issuance instruction by pressing the ISSUE MAINTENANCE CODE button Bt1. After obtaining the code issuance instruction, in S8 the terminal device 200 transmits a code issuance request to the server 300.

Upon receiving a code issuance request, in S9 the server 300 issues and records a maintenance code. The maintenance code is a randomly generated character string or plurality of numbers, for example. In the present embodiment, the maintenance code is a five-digit number. As illustrated in the box F2 depicted dashed lines in FIG. 2A, the maintenance code “CD_a” is recorded in the job management table MT in association with the job ID “MID_a”. Specifically, in the present embodiment, the server 300 issues a five-digit number “34567” as the maintenance code, for example, and records the issued number “34567” in the field of the maintenance code associated with the job ID included in the code issuance request received from the terminal device 200 in S8 in the job management table MT (the box F2 in FIG. 2A). Note that in the following description and FIG. 2A, “MID_a” may be used as a kind of reference symbol representing the five-digit number “34567” itself for convenience of explanation, as well as the job ID described above.

In S10 the server 300 transmits the maintenance code to the terminal device 200. Upon receiving the maintenance code, in S12 the terminal device 200 displays the maintenance code on the display unit 240. In the present embodiment, the maintenance screen TW in FIG. 7 is provided with a maintenance code display field TB, and the maintenance code “34567” is displayed in the maintenance code display field TB.

The operator instructs the user of the MFP 100, over the telephone, for example, to display an initial screen DW1 on the display unit 140 of the MFP 100. At this time, the user performs an operation to restart the MFP 100, for example, in accordance with the instructions, and in S13 the MFP 100 (the CPU 110) displays the initial screen DW1 on the display unit 140.

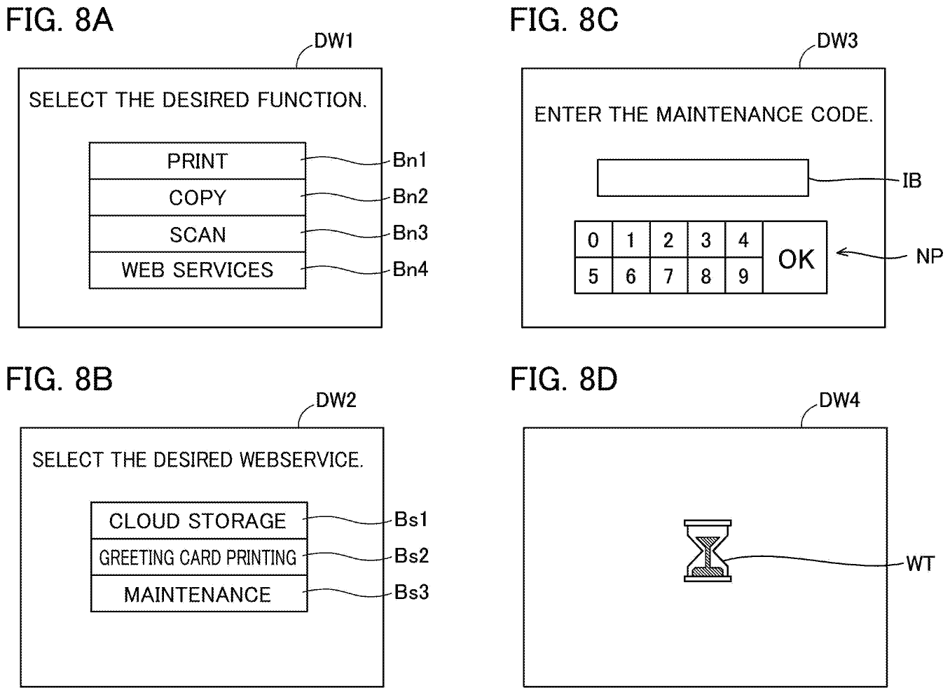

FIGS. 8A through 8D illustrate examples of display screens on the MFP 100. The initial screen DW1 in FIG. 8A includes buttons Bn1 through Bn3 for selecting various functions of the MFP 100, and specifically the print function, copy function, and scan function, respectively. The initial screen DW1 also includes a WEB SERVICES button Bn4. The WEB SERVICES button Bn4 is operated to select the web services as the function to be performed.

The operator instructs the user of the MFP 100, over the telephone, for example, to press the WEB SERVICES button Bn4. By pressing the WEB SERVICES button Bn4 in accordance with these instructions, the user inputs an instruction to select the web services.

When receiving an input of an instruction to select the web services, in S14 the MFP 100 transmits a service use request to the server 300 requesting the use of the web services. Specifically, the CPU 110 of the MFP 100 executes a web browser program included in the computer program PGp. Communication with the server 300 is executed by the CPU 110 functioning as a web browser. That is, communication between the MFP 100 and server 300 is implemented through HTTP. The MFP 100 transmits data to the server 300 as an HTTP request, and the server 300 transmits data to the MFP 100 as an HTTP response to the HTTP request received immediately before. For example, a service use request is an HTTP request sent to a prescribed URL. The service use request includes the device ID of the MFP 100, as illustrated in FIG. 3. Although the device ID is included in all HTTP requests the MFP 100 transmits to the server 300 and not just service use requests, this indication has been omitted from other steps in the drawings.

When the server 300 receives a service use request, in S15 the server 300 searches the job management table MT for the device ID of the MFP 100 included in the service use request. Since the device ID of the MFP 100 has not yet been recorded in the job management table MT at this time, the server 300 determines that the device ID is not in the job management table MT.

When the device ID of the MFP 100 is not recorded in the job management table MT, in S16 the server 300 transmits menu screen data to the MFP 100. A case in which the device ID of the MFP 100 is recorded in the job management table MT will be described later. Upon receiving the menu screen data, in S18 the MFP 100 displays a menu screen DW2 on the display unit 140 based on the menu screen data.

FIG. 8B illustrates an example of the menu screen DW2 that includes buttons Bs1 through Bs3 for selecting available web services. These buttons include a MAINTENANCE button Bs3 for selecting the maintenance service described above.

The operator instructs the user of the MFP 100, over the telephone, for example, to press the MAINTENANCE button Bs3. By pressing the MAINTENANCE button Bs3 in accordance with these instructions, the user inputs an instruction to select the maintenance service.

After receiving a user input of an instruction to select the maintenance service, in S20 the MFP 100 transmits a maintenance request to the server 300 requesting the server 300 to provide the maintenance service. Upon receiving a maintenance request, in S22 the server 300 transmits code entry screen data to the MFP 100. When the MFP 100 receives this code entry screen data, in S24 the MFP 100 displays a code entry screen DW3 on the display unit 140 based on the code entry screen data.

FIG. 8C illustrates an example of the code entry screen DW3 that includes an input field IB for displaying an inputted maintenance code, and a button set NP for inputting the maintenance code.

Over the telephone, for example, the operator tells the user of the MFP 100 the maintenance code that has been displayed in the maintenance screen TW on the terminal device 200 in S12 and instructs the user to input this maintenance code into the code entry screen DW3 displayed on the MFP 100. In accordance with these instructions, the user enters the maintenance code in the input field IB through operations on the button set NP displayed in the code entry screen DW3, thereby inputting the maintenance code into the MFP 100 through the code entry screen DW3. After acquiring the maintenance code, in S26 the MFP 100 transmits this maintenance code to the server 300.

After receiving the maintenance code, in S28 the server 300 uses this maintenance code to associate the device ID of the MFP 100 with the job ID issued in S3 and sent to the terminal device 200 in S4. Specifically, the server 300 searches the job management table MT for the maintenance code received from the MFP 100. As illustrated in the box F3 depicted by dashed lines in the example of FIG. 2A, the device ID “DID_a” of the MFP 100 is recorded in the job management table MT in association with the job ID “MID_a”. Specifically, in the present embodiment, the server 300 records the device ID of the MFP 100 in the field of the device ID associated with the maintenance code found in the job management table MT (the box F3 in FIG. 2A). Note that in the following description and drawings, “DID_a” is used as a kind of reference symbol representing the device ID itself for convenience of explanation, as well as the job ID and maintenance code described above. In this way, the job ID is associated with a communication session described later to be established between the MFP 100 and server 300. At this time, the maintenance code may be deleted from the job management table MT since the maintenance code is no longer necessary once the device ID “DID_a” has been associated with the job ID “MID_a”.

In S30 and S32 the server 300 establishes a communication session with the MFP 100. In the present embodiment, establishing a communication session with the MFP 100 signifies that the server 300 establishes a communication state in which the server 300 can transmit HTTP responses to the MFP 100 at arbitrary timings. Thus, at any given time, the server 300 can transmit a configuration information transmission request or a configuration information modification request described later to the MFP 100. The server 300 can also transmit an HTTP response as a response to an HTTP request received from the MFP 100, but this HTTP response must be sent within a predetermined timeout period (e.g., from several seconds to several hundreds of seconds) after receipt of the HTTP request. Once this predetermined timeout period has elapsed after the receipt of the HTTP request, the server 300 can no longer transmit an HTTP response to the MFP 100 until another HTTP request is received from the MFP 100.

Accordingly, in S30 the server 300 transmits a prescribed information request (an HTTP response) to the MFP 100 within the predetermined timeout period from receipt of the maintenance code in S26 (receipt of an HTTP request) requesting the MFP 100 to transmit prescribed information. This prescribed information request (the HTTP response) does not include screen data. When the MFP 100 receives an HTTP response that contains no screen data, the MFP 100 continually displays a prescribed standby screen DW4 until an HTTP response containing screen data is subsequently received. FIG. 8D illustrates an example of the standby screen DW4 that includes a predetermined icon WT indicating that the MFP 100 is waiting, for example. Since this prescribed information request is transmitted to establish and maintain a communication session, the prescribed information may be any information, such as a flag or other information having a small quantity of data.

The web browser of the MFP 100 has a function for transmitting, immediately after receiving an information request as an HTTP response, an HTTP request containing the information specified in the information request. Thus, when the MFP 100 receives a prescribed information request, in S32 the MFP 100 transmits the specified information to the server 300 as an HTTP request. When the server 300 receives the prescribed information (the HTTP request), the server 300 can transmit an HTTP response to the MFP 100 at any time within the predetermined timeout period from this point.

Thereafter, the server 300 periodically and repeatedly transmits another prescribed information request (an HTTP response) to the MFP 100 within the predetermined timeout period from the receipt of the previous HTTP request. In other words, the server 300 periodically repeats the transmission of prescribed information requests (HTTP responses) and the reception of prescribed information (HTTP requests). This enables the server 300 to maintain the communication session.

After the device ID of the MFP 100 has been associated with the job ID transmitted to the terminal device 200 (S28) and a communication session has been established between the server 300 and MFP 100 (S30, S32), the server 300 can transmit requests to the MFP 100 based on instructions received from the terminal device 200.

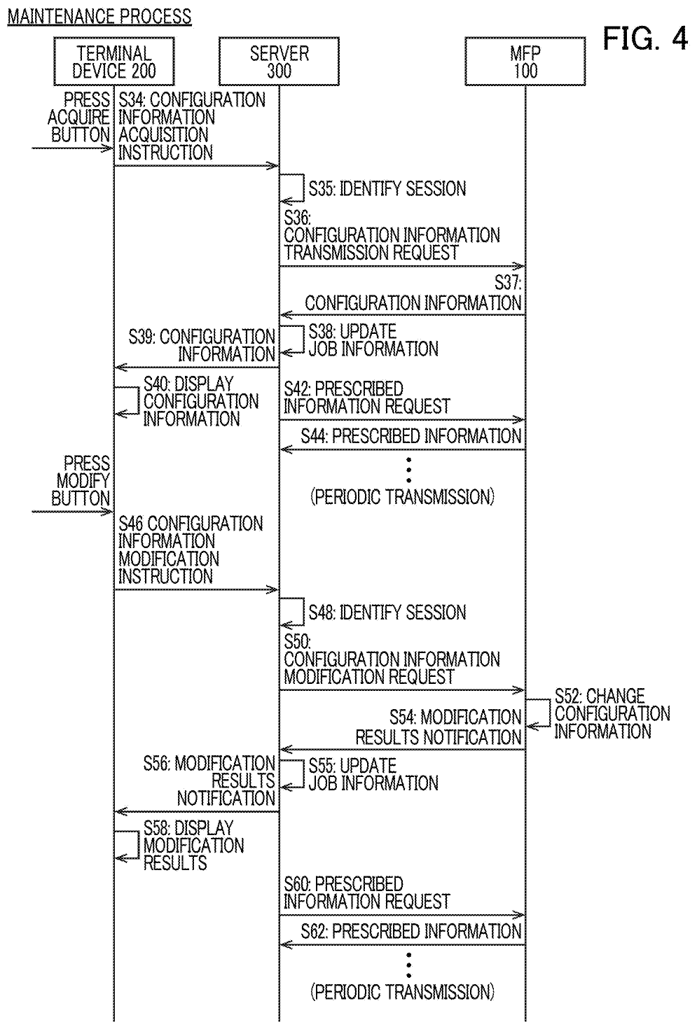

For example, the operator listens to the user explain over the telephone the problem that the user is having with the MFP 100, thereby identifying what configuration information on the MFP 100 the operator should acquire. The operator then specifies via the maintenance screen TW the configuration information to acquire and inputs an instruction to acquire this configuration information into the terminal device 200. The maintenance screen TW illustrated in the example of FIG. 7 includes a pull-down menu PM2 for selecting a category of configuration information, and an ACQUIRE button Bt2. The operator operates the pull-down menu PM2 to specify what category of configuration information needs to be obtained (e.g., print settings, scan settings, or network settings) and presses the ACQUIRE button Bt2 (see FIG. 4).

After the operator has pressed the ACQUIRE button Bt2, in S34 of FIG. 4, the terminal device 200 transmits a configuration information acquisition instruction to the server 300 for acquiring the specified configuration information. Upon receiving the configuration information acquisition instruction, in S35 the server 300 identifies the communication session with the device from which the configuration information should be acquired. Since the server 300 may be accessed by multiple devices, communication sessions with a plurality of devices including the MFP 100 may be established simultaneously. Specifically, the configuration information acquisition instruction received from the terminal device 200 includes a job ID, as described above. The server 300 searches the job management table MT for this job ID and identifies the device ID associated with the job ID found in the job management table MT. The server 300 then identifies the communication session established with the device having the identified device ID. In this example, in S35 of FIG. 4 the server 300 identifies the communication session established with the MFP 100.

In S36 the server 300 uses the communication session identified in S35 to transmit a configuration information transmission request to the MFP 100 requesting that the MFP 100 transmit the configuration information specified in the configuration information acquisition instruction. That is, this configuration information transmission request is transmitted to the MFP 100 as an HTTP response to the prescribed information described above (the HTTP request), which has been transmitted from the MFP 100 in order to maintain the communication session.

Upon receiving this configuration information transmission request, in S37 the MFP 100 acquires the specified configuration information from the configuration information database SD and transmits this configuration information to the server 300. As an example, when the print density settings are specified as the configuration information, the MFP 100 transmits information on the density settings recorded in the print density settings table PT (see FIG. 2B) for all CMYK colors of ink to the server 300. After receiving this configuration information, in S38 the server 300 updates the job information associated with the job ID sent to the terminal device 200 and the device ID of the MFP 100. In the specific example of FIG. 2A, the server 300 updates the job information “SD_a” designated in the box F4 depicted by dashed lines in FIG. 2A. For example, the server 300 adds the configuration information received from the MFP 100 to the job information. Note that in the following description and drawings, “SD_a”, which is listed as job information, is not itself the data representing job information recorded in the job management table MT, but is used for convenience of explanation as a kind of reference symbol representing the data itself recorded in the field of job information in the job management table MT (the box F4 in FIG. 2A).

In S39 the server 300 transmits the configuration information received from the MFP 100 to the terminal device 200. As a modification, instead of transmitting the received configuration information to the terminal device 200 as is, the server 300 may first process the received configuration information into a more easily comprehensible form for the operator and may transmit the resulting information to the terminal device 200. Alternatively, the server 300 may transmit screen data representing a display screen that includes the received configuration information to the terminal device 200. The server 300 transmits this configuration information as a response to the configuration information acquisition instruction received from the terminal device 200 in S34, for example.

After receiving this configuration information, in S40 the terminal device 200 displays the configuration information on the display unit 240. For example, the maintenance screen TW may be provided with a display area SA for displaying configuration information. In this case, the terminal device 200 displays the configuration information received from the server 300 in the display area SA of the maintenance screen TW. In the example of FIG. 7, density settings for the CMYK colors of ink are displayed in the display area SA.

In S42 the server 300 transmits a prescribed information request similar to that described in S30 of FIG. 3 to the MFP 100 within the predetermined timeout period from receipt of the configuration information as a response (an HTTP response) to the configuration information received in S37 (an HTTP request). Upon receiving the prescribed information request, in S44 the MFP 100 transmits the prescribed information to the server 300 as an HTTP request, as described in S32 of FIG. 3. The server 300 then periodically repeats this transmission of prescribed information requests described in S42 (HTTP responses) and the reception of prescribed information described in S44 (HTTP requests). This allows the server 300 to continue maintaining the communication session with the MFP 100 after receiving the configuration information in S37.

The operator can confirm the requested configuration information on the MFP 100, which is now displayed in the maintenance screen TW on the terminal device 200, to determine what configuration information needs to be modified in order to resolve the issue with the MFP 100. As an example, if cyan (C) areas of images printed on the MFP 100 tend to be too light, the operator checks the current value of the cyan density setting. The operator may then determine that the problematic issue with the MFP 100 can be resolved by changing the value of the cyan density setting to a value greater than the current value. In this case, the operator specifies the configuration information to be modified and the new value for the configuration information and inputs an instruction into the terminal device 200 to change the configuration information. The maintenance screen TW in the example of FIG. 7 includes an input field NB for inputting the new value for the configuration information displayed in the display area SA, and a MODIFY button Bt3. The operator enters the desired value in the input field NB (FIG. 7) and presses the MODIFY button Bt3.

After the operator presses the MODIFY button Bt3, in S46 the terminal device 200 transmits a configuration information modification instruction to the server 300 for changing the specified configuration information to the specified value. Upon receiving the configuration information modification instruction, in S48 the server 300 identifies the communication session with the device whose configuration information is to be modified. Specifically, as described above for S35, the server 300 searches the job management table MT for the job ID included in the configuration information modification instruction, identifies the device ID associated with this job ID in the job management table MT, and identifies the communication session with the device having the identified device ID. Thus, in S48 of FIG. 4 the server 300 identifies the communication session with the MFP 100.

In S50 the server 300 uses the communication session identified in S48 to send a configuration information modification request to the MFP 100, requesting that the MFP 100 modify the configuration information specified in the configuration information modification instruction to the specified value. In other words, as with the configuration information transmission request, the configuration information modification request is transmitted to the MFP 100 as an HTTP response to the prescribed information (an HTTP request) sent from the MFP 100 in order to maintain the communication session.

When the MFP 100 receives a configuration information modification request, in S52 the MFP 100 searches the configuration information database SD for the specified configuration information and changes the value for the configuration information to the specified value. Using the above example, the MFP 100 changes the value for the cyan density setting in the print density settings table PT described above. In S54 the MFP 100 transmits a modification results notification to the server 300 specifying that modification of the configuration information is complete. Upon receiving this modification results notification, in S55 the server 300 updates the job information associated with the job ID sent to the terminal device 200 and the device ID of the MFP 100 (the job information “SD_a” in FIG. 2A). For example, the server 300 adds the modification results notification for the configuration information of the MFP 100 to the job information.

In S56 the server 300 transmits the modification results notification received from the MFP 100 to the terminal device 200. The server 300 sends this modification results notification to the terminal device 200 as a response to the configuration information modification instruction received from the terminal device 200 in S46, for example.

Upon receiving the modification results notification, in S58 the terminal device 200 displays modification results on the display unit 240 based on the modification results notification. The maintenance screen TW in the example of FIG. 7 is provided with a message display area MB for displaying messages to the operator. The terminal device 200 displays modification results for configuration information in the message display area MB of the maintenance screen TW, for example. In the example illustrated in FIG. 7, a message indicating that the cyan density setting has been modified is displayed in the message display area MB.

In S60 the server 300 transmits a prescribed information request similar to that described in S30 of FIG. 3 to the MFP 100 within the predetermined timeout period from the receipt of the modification results notification as a response (an HTTP response) to the modification results notification received in S54 (an HTTP request). Upon receiving the prescribed information request, in S62 the MFP 100 transmits prescribed information to the server 300 as an HTTP request, as in S32 of FIG. 3. The server 300 periodically repeats the transmission of a prescribed information request similar to that described in S60 (an HTTP response) and the reception of prescribed information similar to that described in S62 (an HTTP request). This enables the server 300 to continue maintaining the communication session with the MFP 100 after receiving the modification results notification in S54.

The operator may also restart the MFP 100 in the maintenance process. For example, a problem with the MFP 100 may be resolved by restarting the MFP 100. It may also be necessary to restart the MFP 100 after modifying configuration information on the MFP 100 in order to activate the modified configuration information.

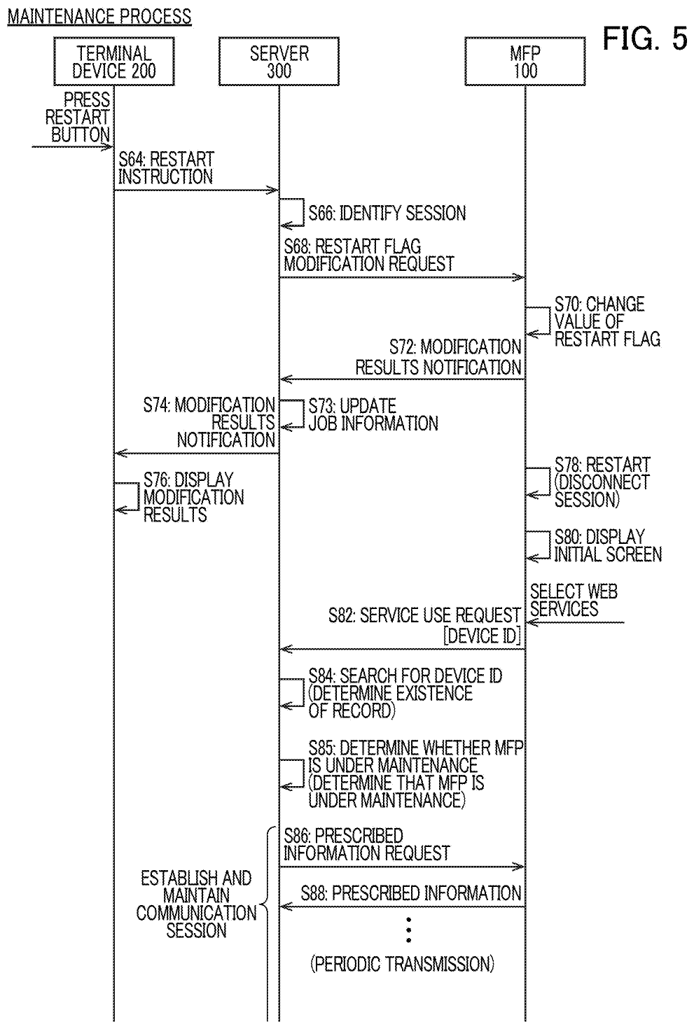

To restart the MFP 100, the operator inputs a restart instruction into the terminal device 200 via the maintenance screen TW. The maintenance screen TW in the example of FIG. 7 includes a RESTART button Bt4 that the operator presses for this purpose (see FIG. 5).

When the operator presses the RESTART button Bt4, in S64 of FIG. 5 the terminal device 200 transmits a restart instruction to the server 300 for restarting the MFP 100. Upon receiving the restart instruction, in S66 the server 300 identifies the communication session with the device to be restarted. Specifically, as in S35 of FIG. 4 described above, the server 300 searches the job management table MT for the job ID included in the restart instruction, identifies the device ID associated with this job ID in the job management table MT, and identifies the communication session with the device having the identified device ID. Thus, in S66 of the example in FIG. 5, the server 300 identifies the communication session with the MFP 100.

In S68 the server 300 uses the communication session identified in S66 to transmit a restart flag modification request to the MFP 100 requesting the MFP 100 to change the restart flag to ON. That is, this restart flag modification request is transmitted to the MFP 100 as an HTTP response to the prescribed information described above (an HTTP request), which the MFP 100 has transmitted in order to maintain the communication session. The restart flag modification request is a request to modify information recorded in the configuration information database SD and, hence, is a type of the configuration information modification request described above.

When the MFP 100 receives the restart flag modification request, in S70 the MFP 100 changes the value of the restart flag in the flag table FT (see FIG. 2B) from OFF to ON. In S72 the MFP 100 transmits a modification results notification to the server 300 indicating that modification of the restart flag is complete. Upon receiving the modification results notification, in S73 the server 300 updates the job information associated with the job ID sent to the terminal device 200 and the device ID of the MFP 100 (the job information “SD_a” in FIG. 2A). For example, the server 300 adds the modification results notification for the restart flag on the MFP 100 to the job information.

In S74 the server 300 transmits the modification results notification received from the MFP 100 to the terminal device 200. The server 300 transmits this modification results notification to the terminal device 200 as a response to the restart instruction received from the terminal device 200 in S64, for example.

Upon receiving the modification results notification, in S76 the terminal device 200 displays modification results on the display unit 240 based on this modification results notification. For example, the terminal device 200 displays a message in the message display area MB of the maintenance screen TW illustrated in FIG. 7 indicating that the MFP 100 has been instructed to restart.

In the meantime, in S78 the MFP 100 restarts as a result of the restart flag being changed to ON. After this restart, the restart flag is automatically changed back from ON to OFF (not shown in the drawings). Since all processes in progress prior to the restart are interrupted by restarting, the MFP 100 is no longer capable of receiving HTTP responses from the server 300. In other words, the restart terminates (disconnects) the communication session between the server 300 and the MFP 100. Consequently, the server 300 must receive an HTTP request from the MFP 100 in order to transmit instructions to the MFP 100 for acquiring or modifying configuration information. Just as when the MFP 100 is normally turned on, in S80 the restarted MFP 100 displays the initial screen DW1 on the display unit 140 (see FIG. 8A).

After the MFP 100 is restarted, the operator may wish to confirm whether the configuration information changed prior to the restart is reflected in the configuration information database SD, for example. Further, when the issue with the MFP 100 is not resolved after restarting, the operator may wish to acquire or modify other configuration information. In such cases, the operator continues the maintenance process. Specifically, the operator instructs the user over the telephone to press the WEB SERVICES button Bn4 in the initial screen DW1 displayed on the display unit 140 of the MFP 100 (see FIG. 8A). By pressing the WEB SERVICES button Bn4 in accordance with the operator's instructions, the user inputs an instruction to select the web services.

After receiving an input of an instruction to select the web services, in S82 the MFP 100 transmits a service use request to the server 300, as described in S14 of FIG. 3.

When the server 300 receives the service use request, in S84 the server 300 searches the job management table MT for the device ID included in the service use request, as in S15 of FIG. 4. Since the device ID “DID_a” of the MFP 100 is recorded in the job management table MT at this time, the server 300 determines that the device ID of the MFP 100 is recorded. Since the device ID “DID_a” of the MFP 100 is already associated with the job ID “MID_a” in the job management table MT, there is no need for the server 300 to receive a maintenance code from the device (MFP 100) after the device (MFP 100) has restarted. In other words, the server 300 receives both the device ID and maintenance code from the MFP 100 (S14 and S26 of FIG. 3) when initially establishing a communication session with the MFP 100. However, after the MFP 100 is restarted, the server 300 only receives the device ID from the MFP 100 (S82 of FIG. 5) to re-establish a communication session with the MFP 100 and need not receive a maintenance code.

When the device ID of the MFP 100 is recorded in the job management table MT, in S85 the server 300 references the job information “SD_a” associated with the device ID “DID_a” of the MFP 100 in the job management table MT to determine whether the MFP 100 is under maintenance. When maintenance on the MFP 100 has been completed, information indicating that a completion notification has been transmitted to the MFP 100 should be recorded in the job information “SD_a”, as will be described later. The server 300 determines that the MFP 100 is under maintenance when information indicating that a completion notification has been sent to the MFP 100 is not recorded in the job information “SD_a” and determines that the MFP 100 is not under maintenance when such information is recorded in the job information “SD_a”. In this example, the server 300 determines that the MFP 100 is still under maintenance at the timing of S85 in FIG. 5.

When the server 300 determines that the MFP 100 is under maintenance, in S86 and S88 the server 300 establishes a communication session, as described in S30 and S32 of FIG. 3. That is, in S86 the MFP 100 transmits a prescribed information request (an HTTP response) to the MFP 100 within the predetermined timeout period from receipt of the service use request in S82 (receipt of an HTTP request). Upon receiving the prescribed information request, in S88 the MFP 100 transmits the specified prescribed information to the server 300 as an HTTP request. The server 300 periodically repeats the action of transmitting a prescribed information request (an HTTP response) to the MFP 100 within the predetermined timeout period from receipt of the previous HTTP request. In other words, the server 300 periodically repeats the transmission of prescribed information requests (HTTP responses) and the reception of prescribed information (HTTP requests). This allows the server 300 to re-establish and maintain a communication session with the MFP 100 after the previous communication session was terminated due to restarting the MFP 100.

Since the MFP 100 receives a prescribed information request (an HTTP response) that contains no screen data, the MFP 100 continually display the standby screen DW4 shown in FIG. 8D on the display unit 140 until the next HTTP response containing screen data is received, as described above.

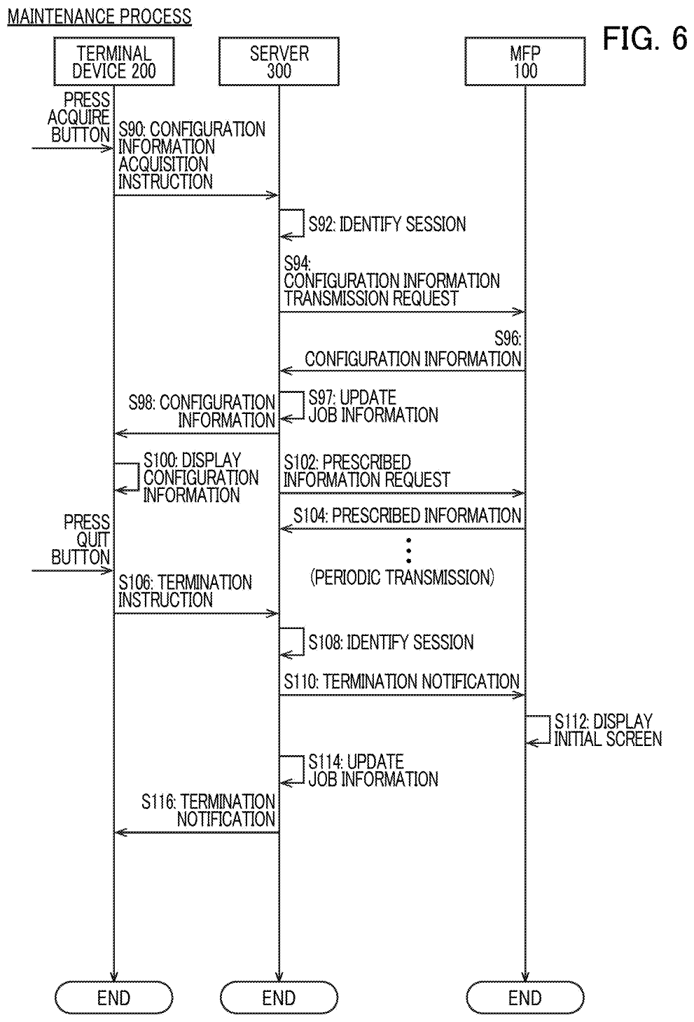

After a communication session with the MFP 100 is re-established and being maintained, the server 300 can acquire and modify configuration information on the MFP 100 in response to configuration information acquisition instructions and configuration information modification instructions from the terminal device 200. Accordingly, the operator can continue to have maintenance performed on the MFP 100. FIG. 6 illustrates an example of a process of acquiring configuration information from the MFP 100 in response to a configuration information acquisition instruction received from the terminal device 200. The process in S90 through S104 of FIG. 6 is identical to that in S34 through S44 of FIG. 4.

The operator decides to terminate the maintenance process on the MFP 100 when the malfunction of the MFP 100 has been resolved or when the malfunction cannot be resolved simply by modifying configuration information, for example. In such cases, the operator inputs an instruction to terminate the maintenance process into the terminal device 200 via the maintenance screen TW. For example, the maintenance screen TW in the example of FIG. 7 includes a QUIT button Bt5 that the operator presses to terminate the maintenance process (see FIG. 6).

When the operator presses the QUIT button Bt5, in S106 the terminal device 200 transmits a termination instruction to the server 300 to terminate the maintenance process. Upon receiving this termination instruction, in S108 the server 300 identifies the communication session with the device for which maintenance is to be terminated. Specifically, as in S35 described above, the server 300 searches the job management table MT for the job ID included in the termination instruction, identifies the device ID associated with the job ID in the job management table MT, and identifies the communication session with the device having the identified device ID. Thus, in the example of FIG. 6, the server 300 identifies the communication session with the MFP 100 in S108.

In S110 the server 300 uses the communication session identified in S108 to transmit a maintenance termination notification to the MFP 100. That is, as with a configuration information transmission request or a configuration information modification request, the server 300 transmits this termination notification to the MFP 100 as an HTTP response to the prescribed information (an HTTP request) that the MFP 100 has transmitted for maintaining the communication session.

Upon receiving the termination notification, in S112 the MFP 100 displays the initial screen DW1 on the display unit 140. In the meantime, after transmitting the termination notification to the MFP 100, in S114 the server 300 updates the job information associated with the job ID transmitted to the terminal device 200 and the device ID of the MFP 100 (the job information “SD_a” in FIG. 2A). Specifically, the server 300 adds information to the job information indicating that a termination notification has been transmitted to the MFP 100.

In S116 the server 300 transmits a termination notification to the terminal device 200 as a response to the termination instruction received from the terminal device 200 in S106, and subsequently ends the maintenance process.

According to the embodiment described above, the server 300 establishes a communication session with the MFP 100 (S30 and S32 of FIG. 3) in response to a maintenance request received from the MFP 100 (S20 of FIG. 3). The server 300 communicates with the MFP 100 using this communication session to perform a specific process related to configuration information on the MFP 100 (a maintenance process for the MFP 100 in the present embodiment). Specifically, when the server 300 receives an acquisition instruction from the terminal device 200 to acquire configuration information on the MFP 100 (S34 of FIG. 4), the server 300 uses the communication session to transmit a configuration information transmission request to the MFP 100 (S36 of FIG. 4). In response to this configuration information transmission request, the server 300 receives configuration information from the MFP 100 using the communication session (S37 of FIG. 4). Upon receiving the configuration information, the server 300 transmits information based on the configuration information (the configuration information itself in the present embodiment) to the terminal device 200 (S39 of FIG. 4). When the server 300 receives a modification instruction from the terminal device 200 to change configuration information on the MFP 100 (S46 of FIG. 4), the server 300 uses the communication session to transmit a configuration information modification request to the MFP 100 (S50 of FIG. 4).

As a result, the operator of the terminal device 200 can reference the configuration information on the MFP 100 at a separate location from the location at which the MFP 100 is installed, for example. Furthermore, the operator of the terminal device 200 can modify configuration information on the MFP 100, even when in a location different from the installation location of the MFP 100, for example. Thus, by referencing and modifying configuration information on the MFP 100 through remote operations, the operator of the terminal device 200 can perform maintenance on the MFP 100, such as adjusting configuration information on the MFP 100, thereby reducing the burden on the user of the MFP 100. The user need only perform simple operations on the MFP 100 in accordance with instructions from the operator (e.g., inputting a maintenance code and pressing a button). Moreover, the operator at the service center need not visit the installation site of the MFP 100 but can have maintenance performed on the MFP 100 through remote operations, which also reduces the burden on the operator.

Furthermore, after establishing a communication session with the MFP 100 in the present embodiment (i.e., after initially executing the process in S30 and S32 of FIG. 3), the server 300 uses the communication session to transmit a response request (the prescribed information request in the embodiment) to the MFP 100 in order to maintain the communication session with the MFP 100 (S30 of FIG. 3) until the server 300 receives either a configuration information acquisition instruction or a configuration information modification instruction from the terminal device 200. This prevents the communication session from expiring (being disconnected) after the session has been established until a configuration information acquisition instruction or a configuration information modification instruction is received from the terminal device 200. In other words, the server 300 can maintain its ability to transmit requests for configuration information to the MFP 100 at any given timing. Accordingly, when a configuration information acquisition instruction or a configuration information modification instruction is received from the terminal device 200, the server 300 can quickly receive configuration information from the MFP 100 and modify configuration information on the MFP 100.

In the present embodiment, the communication session with the MFP 100 is associated with a job ID that identifies the maintenance process (FIG. 2A; S3 of FIG. 3). The server 300 receives a configuration information acquisition instruction associated with the job ID from the terminal device 200 (S34 of FIG. 4) and transmits a configuration information transmission request to the MFP 100 using the communication session corresponding to the job ID associated with the configuration information acquisition instruction (S35 and S36 of FIG. 4). Similarly, the server 300 receives a configuration information modification instruction associated with the job ID from the terminal device 200 (S46 of FIG. 4) and transmits a configuration information modification request to the MFP 100 using the communication session corresponding to the job ID associated with this configuration information modification instruction (S48 and S50 of FIG. 4). Thus, the server 300 can use the job ID to properly associate instructions from the terminal device 200 with the MFP 100 to be subjected to those instructions, thereby having maintenance performed the appropriate MFP 100, even if a plurality of terminal devices or a plurality of other devices are accessing the server 300 simultaneously, for example.

In the present embodiment, prior to establishing a communication session (S30 and S32 of FIG. 3), the server 300 sets a maintenance code in association with the job ID (S9 of FIG. 3; FIG. 2A). The maintenance code is to be inputted into the MFP 100 by the user of the MFP 100. The server 300 receives the maintenance code inputted by the user from the MFP 100 (S26 of FIG. 3). The server 300 maps the job ID to the communication session with the MFP 100 using the maintenance code (S28 of FIG. 3). Thus, by telling the user the maintenance code, the operator can send requests from the terminal device 200 to the MFP 100 used by the user via the server 300 requesting the MFP 100 to transmit or modify configuration information.

In the present embodiment, when the communication session with the MFP 100 is disconnected due to the MFP 100 restarting (S78 of FIG. 5), the server 300 re-establishes a communication session with the MFP 100 (S86 and S88 of FIG. 5) in response to a request from the MFP 100 (S82 of FIG. 5). When a first communication session (e.g., the session established in S30 and S32 of FIG. 3) with the MFP 100 is disconnected in the middle of a maintenance process executed using the first communication session (S78 of FIG. 5), the server 300 establishes a second communication session (e.g., S86 and S88 of FIG. 5) after the disconnection of the first communication session and uses this second communication session to continue the maintenance process (S90 through S98 of FIG. 6, etc.). The device ID received at the time of establishment of the first communication session and the device ID received at the time of establishment of the second communication session are the same ID “DID_a” (S84 of FIG. 5, etc.). Thus, even if a communication session with the MFP 100 is disconnected in the middle of the maintenance process, the server 300 can properly continue the maintenance process by re-establishing a communication session with the same device (the MFP 100 having the same device ID).

In the present embodiment, the server 300 receives a device ID and a maintenance code from the MFP 100 (S14 and S26 of FIG. 3) for establishing the first communication session (S30 and S32 of FIG. 3) and receives only a device ID and not a maintenance code from the MFP 100 (S82 of FIG. 5) for establishing the second communication session (S86 and S88 of FIG. 5). Thus, when establishing a second communication session with the MFP 100 after a restart of the MFP 100 in the present embodiment, the server 300 need not receive the maintenance code from the MFP 100 again. This can reduce the burden on the user of the MFP 100 since the user need not re-enter the maintenance code in the MFP 100 after the restart of the MFP 100.

In the present embodiment, the first communication session is established (S30 and S32 of FIG. 3) in response to a request that the MFP 100 transmits to the server 300 (the maintenance request in S20 of FIG. 3) when a first instruction (and specifically, an instruction inputted via the MAINTENANCE button Bs3 illustrated in FIG. 8B) is inputted into the MFP 100. However, the second communication session is established (S86 and S88 of FIG. 5) in response to a service use request (S82 of FIG. 5) that the MFP 100 transmits to the server 300 when a second instruction (and specifically, an instruction inputted via the WEB SERVICES button Bn4 illustrated in FIG. 8A) is inputted into the MFP 100. Accordingly, the user need only perform one operation to input the second instruction (pressing the WEB SERVICES button Bn4) from the state in which the initial screen DW1 is displayed. On the other hand, the user must perform two operations to input the first instruction (pressing the WEB SERVICES button Bn4 and pressing the MAINTENANCE button Bs3) from the state in which the initial screen DW1 is displayed. Thus, the number of user operations required to input the second instruction is less than the number of user operations required to input the first instruction. As a result, fewer user operations are required to establish a second communication session in order to continue a maintenance process after the disconnection of the first communication session, thereby further reducing the user's burden.

As is clear from the above description, the job ID in the embodiment is an example of the first identification information, the maintenance code is an example of the second identification information, and the device ID is an example of the third identification information. Further, the prescribed information request in the embodiment is an example of a response request.

### B. Modifications of the Embodiment

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

(1) In the above embodiment, the second communication session is established (S86 and S88 of FIG. 5) in response to a service use request that the MFP 100 transmits to the server 300 (S82 of FIG. 5) when the user inputs a service use request (the second instruction) into the MFP 100 (and specifically, an instruction inputted via the WEB SERVICES button Bn4 illustrated in FIG. 8A).

As an alternative, the MFP 100 may transmit a service use request to the server 300 automatically after restarting in S78 of FIG. 5. For example, a special flag for restarting during maintenance may be recorded in the flag table FT on the MFP 100 separately from the normal restart flag (see FIG. 2B). In S70 of FIG. 5, the MFP 100 sets this special flag to ON in response to a modification instruction from the server 300. When the special flag is set to ON, the MFP 100 automatically transmits a service use request to the server 300 in S82 of FIG. 5 after restarting in S78. Thus, in this modification the MFP 100 need not display the initial screen DW1 in S80 of FIG. 5 and the user need not press the WEB SERVICES button Bn4.

According to the modification (1) described above, the second communication session is established (S86 and S88 of FIG. 5) in response to a request transmitted automatically by the MFP 100 to the server 300 (the service use request transmitted in S82 of FIG. 5) when the MFP 100 is restarted during a maintenance process. Thus, when a first communication session is disconnected to restart the MFP 100 in this modification (1), a second communication session is re-established automatically, thereby further reducing the burden on the user.

(2) In the above embodiment, the server 300 issues a maintenance code in association with the job ID (S9 of FIG. 3), the user inputs this maintenance code into the MFP 100, and the MFP 100 transmits the maintenance code to the server 300 (S26 of FIG. 3). Through this process, the server 300 associates the job ID with the device ID (S28 of FIG. 3).

As an alternative, the terminal device 200 may issue a maintenance code, transmit this maintenance code to the server 300, and display the maintenance code on the display unit 240. In this case, the server 300 associates the maintenance code received from the terminal device 200 with the job ID. Further, the operator of the terminal device 200 may inform the user of the MFP 100 of the maintenance code displayed on the display unit 240, as in the embodiment. The user then inputs the maintenance code into the MFP 100, and the MFP 100 transmits this maintenance code to the server 300, as in the embodiment described above.

Alternatively, the MFP 100 may issue a maintenance code, transmit this maintenance code to the server 300, and display the maintenance code on the display unit 140. In this case, the server 300 associates the maintenance code received from the MFP 100 with the device ID. The user of the MFP 100 can also inform the operator of the terminal device 200 of the maintenance code displayed on the MFP 100. The operator then inputs this maintenance code into the terminal device 200, and the terminal device 200 transmits the inputted maintenance code to the server 300.

In either case, the server 300 can ultimately associate the job ID with the device ID, as in the embodiment. In other words, the server 300 can map the job ID to a communication session with the target device (e.g., the MFP 100).

(3) The job ID may also be associated with the device ID without using a maintenance code. For example, the server 300 transmits a list of times to the terminal device 200 indicating when maintenance requests were received from one or more devices (S20 of FIG. 3). The terminal device 200 displays this list of times in the maintenance screen TW. The operator selects a time from this list indicating when the user pressed the MAINTENANCE button Bs3 on the MFP 100. The server 300 then associates the device ID for the device corresponding to the selected time with the job ID transmitted to the terminal device 200.

(4) Rather than periodically exchanging prescribed information requests and prescribed information to maintain a communication session between the server 300 and MFP 100, as in the embodiment, the communication session between the server 300 and MFP 100 may be implemented according to a well-known protocol for establishing a persistent connection (e.g., the Extensible Messaging and Presence Protocol (XMPP)).

(5) In the above embodiment, when the MFP 100 is restarted during maintenance, the maintenance process is continued using information recorded in the job management table MT prior to the restart (the job ID, device ID, and job information). As an alternative, the server 300 may issue a new job ID and a new maintenance code when the MFP 100 is restarted and repeat the maintenance process in FIG. 3 from the beginning.

(6) The MFP 100 serves as the device in the above embodiment, but any of various devices may be subjected to the maintenance service. Other possible devices include devices that can connect to the server 300 via the internet IT such as printers, scanners, digital cameras, and other image-processing devices, or electrical appliances such as refrigerators, washing machines, and cooking appliances.

(7) While a single server 300 provides the maintenance service in the above embodiment, two or more servers capable of communicating with each other may share responsibilities in providing the maintenance service. For example, a first server that can communicate with the terminal device 200 and a second server that can communicate with the MFP 100 may provide the maintenance service in conjunction with each other by sharing the processes executed by the server 300 in the embodiment.

(8) In the embodiment described above, part of the configuration implemented in hardware may be replaced with software and, conversely, all or part of the configuration implemented in software may be replaced with hardware.

While the invention has been described in detail with reference to a specific embodiment and modifications thereof, the above descriptions are intended to facilitate understanding of the present invention and are not intended to limit the present invention. The present invention may be modified and improved without departing from the spirit of the invention and the scope of the claims and includes equivalents thereof.

What is claimed is:

1. A server comprising:
a communication interface connectable to: a device including a device memory in which configuration information on the device is stored; and a terminal device, the server being communicable with the device and the terminal device via the communication interface; and
a controller configured to perform:
(a) establishing, in response to a specific process request transmitted from the device, a communication session with the device through the communication interface; and
(b) executing a specific process related to the configuration information on the device using the communication session established in (a), the executing in (b) comprising:
(b-1) receiving an acquisition instruction from the terminal device, the acquisition instruction instructing to acquire the configuration information;
(b-2) transmitting, in response to receiving the acquisition instruction in (b-1), a transmission request to the device using the communication session, the transmission request requesting to transmit the configuration information;
(b-3) receiving the configuration information from the device using the communication session;
(b-4) transmitting, in response to receiving the configuration information in (b-3), information based on the configuration information to the terminal device;
(b-5) receiving a modification instruction from the terminal device, the modification instruction instructing to modify the configuration information; and
(b-6) transmitting, in response to receiving the modification instruction in (b-5), a modification request to the device using the communication session, the modification request requesting to modify the configuration information.

2. The server according to claim 1,
wherein the controller is configured to further perform:
(c) transmitting a response request to the device using the communication session established in (a), the response request requesting to transmit a response using the communication session,
wherein the controller repeatedly performs the transmitting in (c) until one of the receiving in (b-1) and the receiving in (b-5) is performed.

3. The server according to claim 1, further comprising:
a server memory,
wherein the controller is configured to further perform:
(d) storing, in the server memory, session information related to the communication session in association with first identification information, the first identification information identifying the specific process,
wherein in the receiving in (b-1), the controller receives the acquisition instruction including the first identification information,
wherein in the transmitting in (b-2), the controller identifies the communication session associated with the first identification information included in the acquisition instruction received in (b-1) and transmits the transmission request using the identified communication session,
wherein in the receiving in (b-5), the controller receives the modification instruction including the first identification information, and
wherein in the transmitting in (b-6), the controller identifies the communication session associated with the first identification information included in the modification instruction received in (b-5) and transmits the modification request using the identified communication session.

4. The server according to claim 3,
wherein the controller is configured to further perform:
(e) issuing, prior to performing the establishing in (a), second identification information used for the specific process, and storing, in the server memory, the issued second identification information in association with the first identification information corresponding to the specific process; and
(f) receiving, from the device, the second identification information inputted into the device by a user of the device, and
wherein the controller performs the storing in (d) in response to receiving the second identification information in (f), and in the storing in (d), the controller stores, in the server memory, the session information related to the communication session with the device serving as a source of the received second identification information in association with the received second identification, thereby associating the session information with the first identification information stored in association with the received second identification information.

5. The server according to claim 4,
wherein the controller is configured to further perform:
(g) receiving, prior to performing the establishing in (a), third identification information from the device, the third identification information identifying the device,
wherein in the establishing in (a), the controller establishes the communication session with the device corresponding to the third identification information received in (g),
wherein when a first communication session with the device established in (a) is disconnected, the controller performs, in response to receiving in (g) the third identification information that is the same as the third identification information received in (g) prior to establishing the first communication session in (a), the establishing in (a) to establish a second communication session with the device from which the first communication session is disconnected, and
wherein when the first communication session is disconnected while the controller is executing the specific process using the first communication session in (b), the controller continues to execute the specific process using the second communication session after the second communication session is established in (a).

6. The server according to claim 5,
wherein in the establishing in (a), the controller establishes the first communication session after receiving the second identification information in (f) and receiving the third identification information in (g), and
wherein in the establishing in (a), the controller establishes the second communication session after receiving the third identification information in (g) and without receiving the second identification information in (f).

7. The server according to claim 5,
wherein in the establishing in (a), the controller establishes the first communication session in response to a first process request transmitted from the device, the device including a user interface, the device transmitting the first process request in response to receiving an input of a first instruction via the user interface after receiving an input of a second instruction via the user interface, and
wherein in the establishing in (a), the controller establishes the second communication session in response to a second process request transmitted from the device, the device transmitting the second process request in response to receiving an input of the second instruction via the user interface.

8. The server according to claim 5,
wherein in the establishing in (a), the controller establishes the first communication session in response to a first process request transmitted from the device, the device transmitting the first process request in response to receiving an input of a first instruction after receiving an input of a second instruction, and
wherein in the establishing in (a), the controller establishes the second communication session in response to a second process request transmitted from the device, the device automatically transmitting the second process request when the device restarts while the controller is executing the specific process using the first communication session in (b).

9. The server according to claim 5,
wherein in the storing in (d), the controller stores, in the server memory, the third identification information received in (g) as the session information.

10. A system comprising:
a device comprising:
a device memory in which configuration information on the device is stored; and
a device controller;
a terminal device comprising:
a terminal controller; and
a server comprising:
a communication interface connectable to the device and the terminal device, the server being communicable with the device and the terminal device via the communication interface; and
a server controller,
wherein the device controller is configured to perform:
(a) transmitting a specific process request to the server,
wherein the server controller is configured to perform:
(b) establishing, in response to the specific process request transmitted from the device in (a), a communication session with the device through the communication interface; and
(c) executing a specific process related to the configuration information on the device using the communication session established in (b),
wherein the terminal controller is configured to perform:
(d) transmitting an acquisition instruction to the server, the acquisition instruction instructing to acquire the configuration information; and
(e) transmitting a modification instruction to the server, the modification instruction instructing to modify the configuration information, and
wherein the executing in (c) comprising:
(c-1) receiving the acquisition instruction transmitted from the terminal device in (d);
(c-2) transmitting, in response to receiving the acquisition instruction in (c-1), a transmission request to the device using the communication session, the transmission request requesting to transmit the configuration information;
(c-3) receiving the configuration information from the device using the communication session;
(c-4) transmitting, in response to receiving the configuration information in (c-3), information based on the configuration information to the terminal device;
(c-5) receiving the modification instruction transmitted from the terminal device in (e); and
(c-6) transmitting, in response to receiving the modification instruction in (c-5), a modification request to the device using the communication session, the modification request requesting to modify the configuration information.

11. A non-transitory computer-readable storage medium storing a set of computer-readable instructions for a server, the server including: a communication interface connectable to: a device including a device memory in which configuration information on the device is stored; and a terminal device, the server being communicable with the device and the terminal device via the communication interface; and a computer, the set of computer-readable instructions, when executed by the computer, causing the server to perform:
(a) establishing, in response to a specific process request transmitted from the device, a communication session with the device through the communication interface; and
(b) executing a specific process related to the configuration information on the device using the communication session established in (a), the executing in (b) comprising:
(b-1) receiving an acquisition instruction from the terminal device, the acquisition instruction instructing to acquire the configuration information;
(b-2) transmitting, in response to receiving the acquisition instruction in (b-1), a transmission request to the device using the communication session, the transmission request requesting to transmit the configuration information;
(b-3) receiving the configuration information from the device using the communication session;
(b-4) transmitting, in response to receiving the configuration information in (b-3), information based on the configuration information to the terminal device;
(b-5) receiving a modification instruction from the terminal device, the modification instruction instructing to modify the configuration information; and
(b-6) transmitting, in response to receiving the modification instruction in (b-5), a modification request to the device using the communication session, the modification request requesting to modify the configuration information.
